(19) United States
(12) Patent Application Publication
(10) Pub. No.: US 2008/0060370 A1
(43) Pub. Date: Mar. 13, 2008

(54) Method of cooling a hybrid power system

(75) Inventors: Kevin J. Keene, Coon Rapids, MN (US); Mitchell E. Peterson, Maple Grove, MN (US)

Correspondence Address: HAMRE, SCHUMANN, MUELLER & LARSON, P.C., P.O. BOX 2902, MINNEAPOLIS, MN, 55402-0902, US

(73) Assignee: Cummins Power Generation Inc., Minneapolis, MN (US)

(21) Appl. No.: 11/520,461

(22) Filed: Sep. 13, 2006

(51) Int. Cl. F25B 27/00; B60H 1/32; F25D 23/12; F25B 31/00

(52) U.S. Cl. 62/236; 62/505; 62/259.2; 62/239

(57) ABSTRACT

A method of controlling a cooling system is provided for a hybrid power system that includes an engine that employs an engine cooling circuit to deliver coolant to the engine, the engine cooling circuit including a radiator and a main fan to draw air through the radiator. When the hybrid power system further includes an inverter, then the inverter is cooled via an inverter cooling circuit that is formulated as one portion of the cooling system to deliver coolant to the inverter, the inverter cooling circuit including a heat exchanger located such that the main fan draws air through the heat exchanger when the main fan is active. The cooling system also includes a secondary fan to selectively draw air though the heat exchanger during operation of an inverter cooling circuit coolant pump.

### BACKGROUND OF THE INVENTION

1. Field of the Invention

This invention relates to the field of power generating systems, and more specifically to a method of cooling a vehicular hybrid power system.

2. Description of the Prior Art

A typical vehicular hybrid power system utilizes both a battery stack and a generator engine unit to develop electrical power. The battery stack can typically be charged from either the generator engine unit or from shore power. The hybrid power system can be used, for example, to generate electrical power for a vehicle such as a recreational vehicle (RV). When utilizing such a hybrid power system onboard a vehicle, problems can arise with the need for cooling the hybrid power system components. Manufacturing costs, maintenance costs, and space requirements are only some of the factors that need to be optimized for such a system.

### SUMMARY OF THE INVENTION

A vehicular hybrid power system generally includes an engine driven electrical power generator and a bank of batteries to provide a dual source of electrical power, and a power conversion assembly such as, but not limited to, an inverter for converting DC power to AC power. A method of cooling the vehicular hybrid power system according to one embodiment of the present invention includes controlling an engine cooling circuit to deliver coolant to the generator engine, the engine cooling circuit including a radiator and a main fan to draw air through the radiator. One embodiment of the present invention also includes a method of controlling a cooling circuit to deliver coolant to the inverter, the inverter cooling circuit including a heat exchanger located such that the main fan also draws air through the heat exchanger when the main fan is active. The method of cooling a vehicular hybrid power system can also include controlling a secondary fan to selectively draw air though the heat exchanger whenever a coolant pump is pumping coolant through the inverter cooling circuit.

### BRIEF DESCRIPTION OF THE DRAWINGS

Other aspects, features and advantages of the present invention will be readily appreciated as the invention becomes better understood by reference to the following detailed description when considered in connection with the accompanying drawing figures wherein:

FIG. 1 is a schematic representation of a hybrid power system including a cooling system for the hybrid power system;

FIG. 2 is a schematic view of one portion of the cooling system for a hybrid power system shown in FIG. 1;

FIG. 3 is a schematic diagram illustrating a control logic suitable for controlling the hybrid power system cooling pump depicted in FIGS. 1 and 2;

FIG. 4 is a schematic diagram illustrating control logic suitable to control the hybrid power system heat exchanger fan depicted in FIGS. 1 and 2;

FIG. 5 is a schematic diagram illustrating another control logic suitable to control the hybrid power system cooling pump depicted in FIGS. 1 and 2; and

FIG. 6 is a schematic diagram illustrating a control logic suitable to control the hybrid power system heat exchanger fan depicted in FIGS. 1 and 2;

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

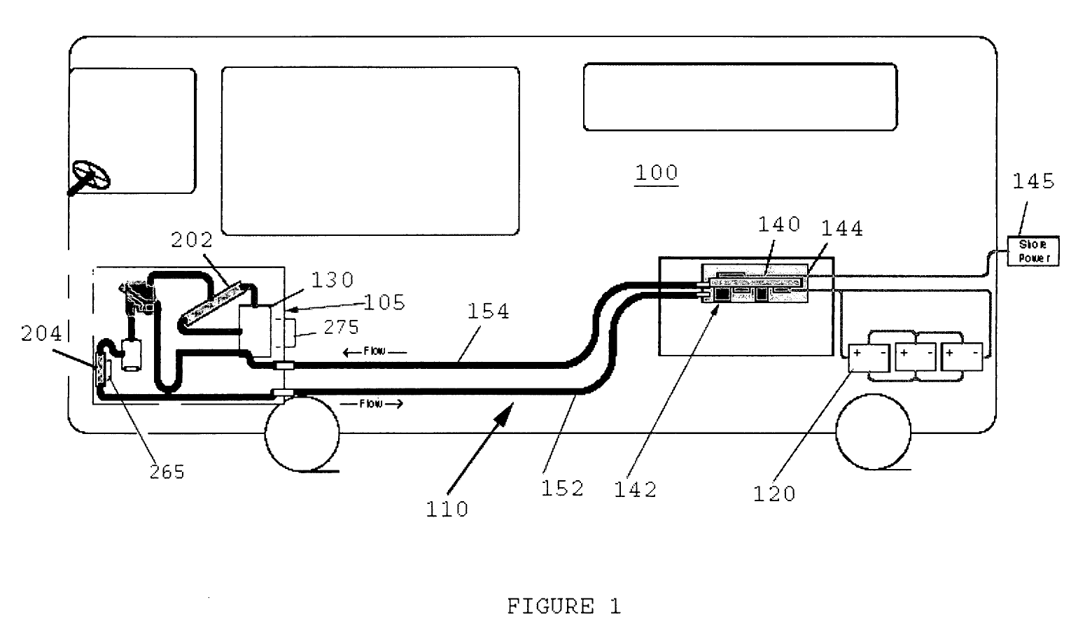

FIG. 1 is a schematic representation of a hybrid power system including a cooling system 110 for the hybrid power system, in accordance with one embodiment. Cooling system 110 is shown embodied within in a recreational vehicle (RV) 100. Other embodiments can utilize cooling system 110 in other types of vehicles, such as, but not limited to, various types of aircraft or watercraft. A vehicular hybrid power generation system generally includes an electrical generator unit 105 including a generator engine 130, a battery bank 120, and a power conversion device such as, but not limited to, an inverter 140. The hybrid power system can also be seen to include an input for shore power 145. These components are operatively coupled to a controller 142 which manages the power requirements of RV 100.

In one embodiment, generator engine 130 can include a variable speed engine. Generator engine 130 receives fuel such as diesel, natural gas or liquid propane vapor through an intake. Generator engine 130 is coupled to an alternator such that as the crankshaft is rotated by the operation of generator engine 130, the crankshaft drives the alternator which, in turn, converts the mechanical energy generated by generator engine 130 to electrical power for transmission and distribution.

Cooling system 110 includes a radiator 202 operatively connected to generator engine 130 such that engine coolant from generator engine 130 circulates through radiator 202 via, for example, a water/coolant pump portion of the generator engine 130 during operation of generator engine 130. Air passes over the radiator 202 so as to effectuate a heat exchange between engine coolant flowing through radiator 202 and the air. In order to draw air over radiator 202, cooling system 110 can include a main fan 275 to draw air across radiator 202 so as to cool generator engine 130 and the engine coolant flowing through the radiator 202.

Battery bank 120 can include a desired number (i.e., six or more) 12V batteries located at a rear portion of the RV 100. These batteries deliver a nominal 12 V DC to inverter assembly 140 which converts the DC to AC power to help power the energy load required by RV 100, along with the energy of the electrical generator unit 105. The power from inverter assembly 140 and the generator unit 105 is managed by the energy management system controller 142 that helps store, manage, and deliver the energy load requirements of the RV 100.

A cooling system such as system 110 requires extensive cooling since the heat developed by inverter assembly 140 and generator engine 130 can be very high. In this embodiment, inverter assembly 140 is designed with a cooling plate 144. Cooling plate 144 receives coolant from the front portion of the RV via a coolant line such as a hose 152. Cooling plate 144 is incorporated into inverter assembly 140 and is adapted to provide enough cooling to allow the use of the inverter assembly 140 in the hybrid power system that includes cooling system 110. In this example, inverter assembly 140 for the hybrid power system is located near the battery bank 120, which traditionally in the rear portion of Class A coaches, such as RV 100, while the generator engine 130 has traditionally been located in the undercarriage slide-out at the front portion of the RV 100. Liquid coolant flows back to the inverter assembly 140 via hose 152 and back to a heat exchanger 204 via hose 154.

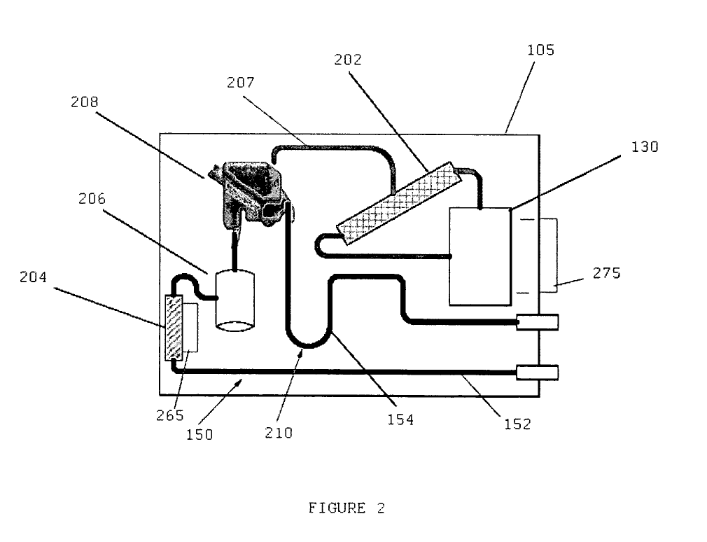

Referring now to FIG. 2, which shows a schematic view of an electrical generator portion 150 of cooling system 110, generator portion 150 can be seen to utilize access to cooling air provided to engine radiator 202 by fan 275 along with a heat exchanger 204 and a pump 206, and transfers the cooling liquid using hoses 152 and 154 to and from inverter assembly 140 such as depicted in FIG. 1. Thus, when active, fan 275 draws air through the electrical generator compartment and through both radiator 202 and heat exchanger 204.

Coolant system portion 150 generally includes generator engine radiator 202, heat exchanger 204, a coolant pump 206, and a coolant tank 208. The cooling system 110 shown in FIG. 1 is designed such that the single coolant tank 208 is operatively coupled to both the generator engine 130 and the inverter assembly 140.

In one embodiment, for example, coolant flows in a first cooling circuit between generator engine 130 and generator engine radiator 202 with overflow being directed to coolant tank 208 via an overflow hose 207. In a second cooling circuit, coolant to the inverter assembly 140 flows from coolant tank 208 through coolant pump 206, through heat exchanger 204 back to the inverter assembly 140 via hose 152 and back to the coolant tank via hose 154 which is coupled to coolant tank 208. In one example, coolant tank 208 performs a dual purpose by acting as an engine coolant overflow for the generator engine cooling circuit and acting as an expansion and pressure head tank for the inverter cooling circuit. Other details of coolant system portion 150 are described in co-pending, co-assigned U.S. patent application Ser. No. ______ (Atty. Docket 20067.0002US01) and co-pending, co-assigned U.S. patent application Ser. No. ______ (Atty. Docket 20067.0003US01), which are incorporated herein by reference in their entirety.

As discussed, heat exchanger 204 receives coolant from the pump 206. In one embodiment, a secondary fan 265 can be used to provide further cooling of the coolant within heat exchanger 204. For example, fan 265 can include an electric fan controlled by controller 142 (or a separate controller) so as to draw air though the heat exchanger 204 when generator engine 130 is not running and fan 275 is not drawing any air through heat exchanger 204. These situations include when the power system 110 is running in battery mode or in shore power charge mode, for example. In these modes, the inverter assembly 140 gets hot, the inverter cooling circuit is used and the coolant running through the inverter cooling circuit needs to be cooled. When cooling system 110 is in a mode where generator engine 130 is running, the main engine cooling fan 275 draws air across heat exchanger 204. In this mode, fan 265 also runs as required, in coordination with coolant pump 206.

Controller 142 is programmed to control when and if the fan 265 and/or the cooling pump 206 need to be turned on and off. The controller 142 can include software and hardware that are programmed to provide the necessary functionality.

For instance, in one example, controller 142 can sense when it is unnecessary to cool the inverter assembly 140 and the controller 142 can turn the cooling pump 206 off. Thus, in one example, pump 206 may operate in any system mode based on factors such as temperature, current, or load thresholds. The thresholds can specify pump on/off conditions, incorporating hysteresis, for example. In some embodiments, minimum pump run times can be enforced, including a minimum run time after transitioning between states.

In one example, the controller 142 observes the temperature of the inverter assembly 140, pump operation status, battery voltage and pump current. Based on these qualifiers, the controller 142 will determine if the pump 206 is nonfunctional or if there is low/no coolant in the system. In other embodiments, if the controller 142 determines that the pump 206 is nonfunctional or there is no/low coolant in the system, then a fault will occur. The controller can also analyze the fan 265 speed and the fan 265 operational status. If the fan 265 speed is zero during commanded operation, the controller 142 will set a fault.

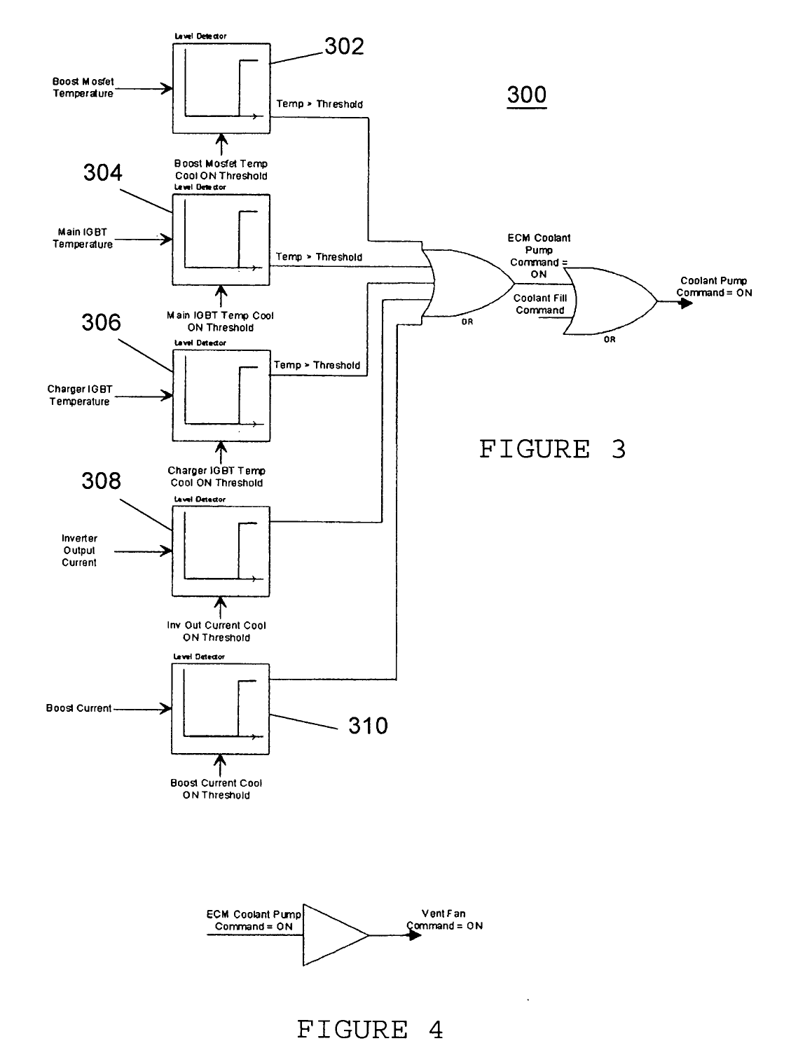

FIG. 3 shows a schematic logic diagram 300 for control of pump 206, in accordance with one embodiment. Here if any of boost MosFET temperature, main IGBT temperature, charger IGBT temperature, boost current, or inverter output current go above a pre-determined temperature threshold, the coolant pump 206 is turned on. The boost MosFET, as well as the main and charger IGBT devices are field effect and bipolar transistors respectively, located within the inverter assembly 140. The main IGBT controls the state of the main fan 175. The charger IGBT controls the state of the inverter assembly 140 during battery charging. The boost MosFET controls the state of the inverter assembly during power boost mode of battery operation. Accordingly, the pump 206 will run whenever temperatures and currents in the inverter dictate necessary operation. In one example, the threshold values are: Charger IGBT: 50 degrees Celsius; Main IGBT: 65 degrees Celsius; Boost MosFET: 60 degrees Celsius; Boost Current: 250 Amps; Inverter Output Current: 30 A. The Boost MosFET, Main IGBT and Charger IGBT are included within inverter assembly 140, as stated herein before.

The cooling system 110 can include temperature sensors located at these positions and at other components. The temperature signals are delivered to controller 142. The controller 142 then will turn the cooling system fan 265 and pump 206 off or on as necessary.

With continued reference to FIG. 3, if the Boost MosFET temperature is greater than a predetermined temperature threshold level as shown in block 302, or if the Main IGBT temperature is greater than a predetermined temperature threshold level as shown in block 304, or if the Charger IGBT temperature is greater than a predetermined temperature level as shown in block 306, or if the Inverter output current is greater than a predetermined current threshold level as shown in block 308, or if the Boost current is greater than a predetermined current threshold level as shown in block 310, a pump command will proceed to activate and turn-on the coolant pump 206. The coolant pump 206 will also turn-on upon receipt of a coolant fill command 312.

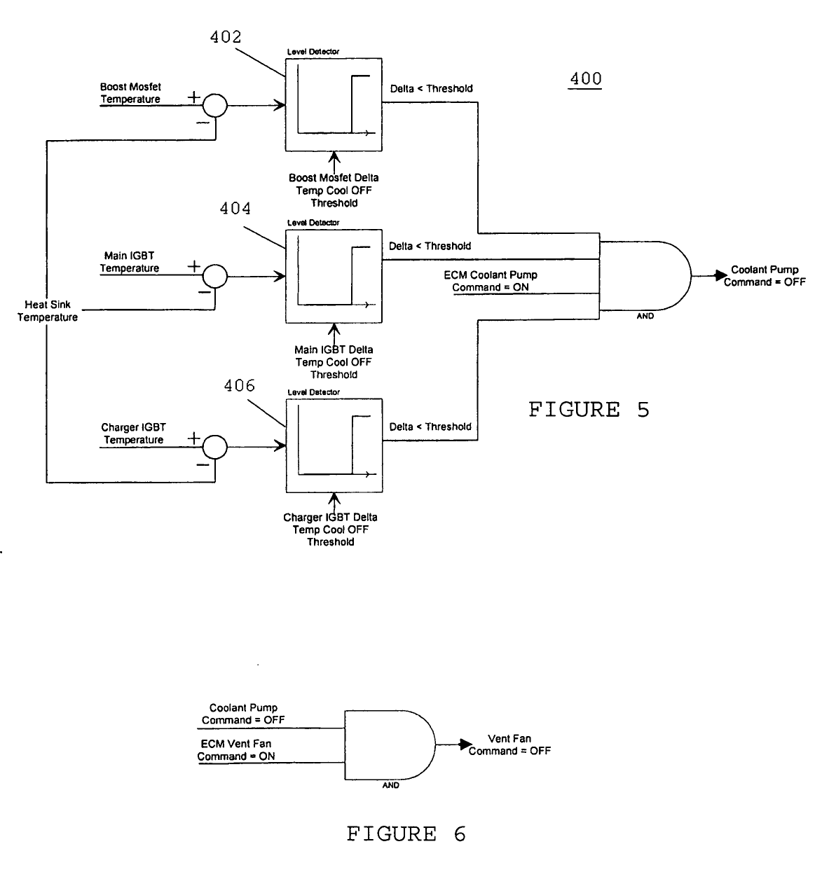

FIG. 5 shows a schematic diagram 400 showing the logic where the controller 142 turns off the pump 206 if the pump 206 is not required. In one embodiment, the controller 142 uses the differences between the temperature points discussed above (charger IGBT, main IGBT, boost mosFET) and the cold plate 144. These temperature differences are called the deltas. Thus, if all of the deltas are below a threshold then the coolant pump 206 is turned off. Thus, pump 206 will turn off whenever the inverter load is low enough to assure that the pump 206 will not need to operate for a substantial period of time (for example, at least about 10 minutes). Generally, a 1 kW steady state inverter load (and often higher loads) produces component temperatures low enough such that the pump 206 does not require operation. By looking at the temperature difference (delta) between the three inverter temperature sensors and the cold plate 144 depicted in FIG. 1, when the temperature difference (delta) has reached a minimum threshold value, it can be assumed the inverter assembly 140 load is low enough to turn off the pump 206. One embodiment uses the following deltas: Charger IGBT delta: 3 degrees C.; Main IGBT delta: 5 degrees C.; Boost mosFET delta: 5 degrees C.

With continued reference to FIG. 5, if the Boost MosFET delta is less than a predetermined threshold level as shown in block 402, or if the Main IGBT delta is less than a predetermined threshold level as shown in block 404, or if the Charger IGBT delta is less than a predetermined threshold level as shown in block 406, then the coolant pump 206 will turn-off, regardless of whether the coolant pump is in receipt of an ON command as shown in FIG. 5.

FIG. 4 shows a schematic logic diagram for operation of secondary fan 265 in accordance with one embodiment. For example, if the coolant pump command is ON, then the secondary fan 265 is turned on. FIG. 6 shows the logic to turn the secondary fan 265 off. If the coolant pump 206 is OFF and the secondary fan 265 is turned off, regardless of whether the secondary fan command is ON. In one example, the controller 142 can sense if the pump 206 and fan 265 are operating, as a diagnostic feature.

In one example, the cooling system 110 can sense whether or not there is coolant available to pump 206, and the controller 142 can be programmed such that if no coolant is available to the pump, the controls and logic provide a fault. For example, the controller 142 (or another controller) observes desired temperature levels within the cooling system 110, the pump 206 operation status, battery voltage and pump current. Based on these qualifiers, the controller 142 can determine the status of the pump or coolant in the system. Using typical pump operation as shown in the Table below, the fault logic can be set accordingly:

| | | | Empty |
|---|---|---|---|
| | | Full Coolant | Coolant |
| | | System | System |
| Temp (C.) | Volt (V) | Current (A) | Current (A) |
| 75 | 14.5 | 3.75 | 1.93 |
| 75 | 10.45 | 2.53 | 1.76 |
| −20 | 14.5 | 4.03 | 2.41 |
| −20 | 10.5 | 3.00 | 2.31 |

The above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A method of controlling a cooling system for a hybrid power system, the method comprising:
providing within a single vehicle, a cooling circuit for a first AC power source and a cooling circuit for a second AC power source;
circulating coolant through the first AC power source cooling circuit during activation of the first AC power source; and
pumping coolant through the second AC power source cooling circuit whenever a predetermined portion of the second AC power source reaches a predetermined temperature level.

2. The method of controlling a cooling system for a hybrid power system according to claim 1, wherein the step of circulating coolant through the first AC power source cooling circuit during activation of the first AC power source comprises activating a coolant circulating system including a main fan to draw cooling air through a radiator/heat exchanger unit such that the first AC power source and the coolant flowing in the first AC power source cooling circuit are cooled by the air flowing through the radiator/heat exchanger during activation of the first AC power source.

3. The method of controlling a cooling system for a hybrid power system according to claim 1, wherein the step of pumping coolant through the second AC power source cooling circuit whenever a predetermined portion of the second AC power source reaches a predetermined temperature level comprises activating a coolant pumping system including a heat exchanger to cool the coolant flowing in the second AC power source cooling circuit.

4. The method of controlling a cooling system for a hybrid power system according to claim 3, further comprising the step of activating an electrically controlled heat exchanger fan to draw cooling air through the heat exchanger such that the coolant flowing in the second AC power source cooling circuit is cooled by the air flowing through the heat exchanger solely during activation of the second AC power source cooling circuit.

5. The method of controlling a cooling system for a hybrid power system according to claim 1, further comprising the step of activating an electrically controlled heat exchanger fan to draw cooling air through a heat exchanger such that the coolant flowing in the second AC power source cooling circuit is cooled by the air flowing through the heat exchanger solely during activation of the second AC power source cooling circuit.

6. The method of controlling a cooling system for a hybrid power system according to claim 1, wherein the step of pumping coolant through the second AC power source cooling circuit whenever a predetermined portion of the second AC power source reaches a predetermined temperature level comprises activating a coolant pumping system to cool a coolant passing through a coolant reservoir that is common to both the first and second AC power source cooling circuits.

7. The method of controlling a cooling system for a hybrid power system according to claim 1, wherein the step of circulating coolant through the first AC power source cooling circuit during activation of the first AC power source comprises activating a coolant circulating system including an engine coolant overflow reservoir that is common to both the first and second AC power source cooling circuits.

8. The method of controlling a cooling system for a hybrid power system according to claim 1, wherein the step of providing within a single vehicle, a cooling circuit for a first AC power source and a cooling circuit for a second AC power source comprises providing a cooling plate configured to receive the coolant passing through the second AC power source cooling circuit such that a desired portion of the second AC power source is cooled to a desired temperature level below the predetermined temperature level.

9. A method of controlling a cooling system for a hybrid power system, the method comprising:
providing within a single vehicle, a cooling circuit for an engine generator unit configured to generate AC power and a cooling circuit for a DC power to AC power converter;
circulating coolant through the engine generator unit cooling circuit during activation of the engine generator unit; and
pumping coolant through the DC power to AC power converter cooling circuit whenever a predetermined portion of the DC power to AC power converter reaches a predetermined temperature level.

10. The method of controlling a cooling system for a hybrid power system according to claim 9, wherein the step of providing within a single vehicle, a cooling circuit for an engine generator unit configured to generate AC power and a cooling circuit for a DC power to AC power converter comprises providing a cooling plate configured to receive the coolant passing through the DC power to AC power converter cooling circuit such that a desired portion of the DC power to AC power converter is cooled to a desired temperature level below the predetermined temperature level.

11. The method of controlling a cooling system for a hybrid power system according to claim 9, wherein the step of circulating coolant through the engine generator unit cooling circuit during activation of the engine generator unit comprises activating a coolant circulating system including a main fan to draw cooling air through a radiator/heat exchanger unit such that the engine generator unit and the coolant flowing in the engine generator unit cooling circuit are cooled by the air flowing through the radiator/heat exchanger during activation of the engine generator unit.

12. The method of controlling a cooling system for a hybrid power system according to claim 9, wherein the step of pumping coolant through the DC power to AC power converter cooling circuit whenever a predetermined portion of the DC power to AC power converter reaches a predetermined temperature level comprises activating a coolant pumping system to cool a coolant passing through a coolant reservoir that is common to both the engine generator cooling circuit and the DC power to AC power converter cooling circuit.

13. The method of controlling a cooling system for a hybrid power system according to claim 9, wherein the step of circulating coolant through the engine generator unit cooling circuit during activation of the engine generator unit comprises activating a coolant circulating system including an engine coolant overflow reservoir that is common to both the engine generator unit cooling circuit and the DC power to AC power converter cooling circuit.

14. The method of controlling a cooling system for a hybrid power system according to claim 9, wherein the step of providing within a single vehicle, a cooling circuit for an engine generator unit and a cooling circuit for a DC power to AC power converter comprises providing a cooling plate configured to receive the coolant passing through the DC power to AC power converter cooling circuit such that a desired portion of the DC power to AC power converter is cooled to a desired temperature level below the predetermined temperature level.

15. A method of controlling a cooling system, the method comprising:
providing a cooling circuit for an engine generator unit configured within a vehicle to generate AC power and a cooling circuit for an inverter configured within the vehicle to convert DC battery power to AC power;
circulating coolant through the engine generator unit cooling circuit during activation of the engine generator unit; and
pumping coolant through the inverter cooling circuit whenever a predetermined portion of the inverter reaches a predetermined temperature level.

16. The method of controlling a cooling system according to claim 15, wherein the step of pumping coolant through the inverter cooling circuit whenever a predetermined portion of the inverter reaches a predetermined temperature level comprises activating a pump controller to energize a coolant pump if any one of multiple temperature points sensed at the inverter are above at least one predetermined threshold.

17. The method of controlling a cooling system according to claim 15, further comprising the step of pumping coolant through the inverter cooling circuit whenever any one of multiple current levels sensed at the inverter are above at least one predetermined threshold.

18. The method of controlling a cooling system according to claim 17, further comprising the step of activating a fan controller to energize a heat exchanger fan configured to pass air through a heat exchanger to cool the coolant passing through the inverter cooling circuit if any one of multiple current points and multiple temperature points sensed at the inverter are above at least one respective predetermined threshold.

19. The method of controlling a cooling system according to claim 15, wherein the step of providing a cooling circuit for an engine generator unit configured within a vehicle to generate AC power and a cooling circuit for an inverter configured within the vehicle to convert DC battery power to AC power, comprises providing a cooling plate configured to receive the coolant passing through the inverter cooling circuit such that a desired portion of the inverter is cooled to a desired temperature level below the predetermined temperature level in response to at least one of multiple temperature levels sensed at the inverter.

20. The method of controlling a cooling system according to claim 15, wherein the step of providing a cooling circuit for an engine generator unit configured within a vehicle to generate AC power and a cooling circuit for an inverter configured within the vehicle to convert DC battery power to AC power, comprises providing a coolant tank common to both the engine generator unit cooling circuit and the inverter cooling circuit, wherein the common coolant tank is configured to operate as a coolant overflow tank for the engine generator unit and is further configured to operate as an expansion and pressure head tank for the inverter cooling circuit.
